(19) United States
(12) Patent Application Publication
(10) Pub. No.: US 2015/0312467 A1
(43) Pub. Date: Oct. 29, 2015

(54) SYSTEM AND METHOD FOR INFORMING PHOTOGRAPHING USING WIRELESS COMMUNICATION

(71) Applicant: ELECTRONICS AND TELECOMMUNICATIONS RESEARCH INSTITUTE, Daejeon (KR)

(72) Inventor: Jae Ho LEE, Daejeon (KR)

(73) Assignee: ELECTRONICS AND TELECOMMUNICATIONS RESEARCH INSTITUTE, Daejeon (KR)

(21) Appl. No.: 14/681,853

(22) Filed: Apr. 8, 2015

(30) Foreign Application Priority Data
Apr. 28, 2014 (KR) 10-2014-0050465

(51) Int. Cl. H04N 5/232

(52) U.S. Cl. CPC H04N 5/23206

(57) ABSTRACT

Disclosed are a system and method for informing photographing using wireless communication, in which a mobile terminal whose photographing function is activated may transmit photographing function activated state information using wireless communication so that surrounding mobile terminals may recognize the transmitted information, and when the corresponding terminal is located in a photographing prohibited area, this may be informed to induce photographing restriction.

### CROSS-REFERENCE TO RELATED APPLICATION

This application claims priority to and the benefit of Korean Patent Application No. 10-2014-0050465, filed on Apr. 28, 2014, the disclosure of which is incorporated herein by reference in its entirety.

### BACKGROUND

1. Field of the Invention

The present invention relates to a system and method for informing photographing, and more particularly, to a system and method for informing photographing, which may inform surrounding mobile terminals that photographing is currently performed at the time of photographing of still images or moving images in a mobile terminal equipped with a camera function, using a wireless communication function, or inform the mobile terminal that photographing is prohibited in a photographing prohibited area, and then block an operation of a camera application programming interface (API).

2. Discussion of Related Art

In recent years, according to the development of information communication technologies, a variety of smart devices have been developed and cameras are generally mounted in such smart devices for a user's convenience.

Secret photographing or photographing without permission using the cameras mounted in the smart devices is treated according to the legal regulations based on the Act on Special Cases concerning the Punishment of Sexual Crimes in which persons who take pictures of another person's body without any consent, using cameras or devices having the similar function, which might arouse sexual desire or shame and persons who distribute, sell, rent, publicly display, or publicly screen the taken pictures are subjected to punishment.

Meanwhile, in order to technically prevent the secret photographing or photographing without permission as well as enhancing the legal regulations for the secret photographing or photographing without permission due to the spread of smartphones with high-performance camera function, conventionally, a photographing sound of a predetermined level or more is required at the time of camera photographing.

However, this technical method is performed only in a camera photographing mode, and in order to avoid this, as one of smartphone applications, it is possible to acquire still images or moving images without a photographing sound of a mobile phone while preventing an opposite party from being aware of it in a method of capturing images in a preview state of a moving image mode rather than the photographing mode.

Thus, the Korean Telecommunications Technology Association recommends a technological alternative that can restrict the illegal use such as photographing without permission using a smartphone mute app or the like other than a photographing sound in “photographing sound of mobile phone camera (TTAK.KO-06.0063/R1)”.

In particular, in “photographing sound of mobile phone camera (TTAK.KO-06.0063/R1)”, there are presented alternatives such as playing the photographing sound when storing files with image or moving image file extensions (JPEG, MPEG, and the like) in a camera preview operation state or a state in which a camera sensor is operated regardless of whether a mobile phone mute mode is set, turning on an LED for confirming a camera operation or periodically operating a camera flash when executing a camera preview, and the like.

However, this technique does not consider legitimate photographing such as photographing a sleeping baby or photographing a pet or the like quietly.

Meanwhile, a method of restricting a camera application programming interface (API) operation by discerning a user's location via global positioning system (GPS) or access point (AP) connection in a camera photographing prohibited area has been used.

Thus, there are demands for a technical security method in which bits for informing that photographing is prohibited may be set in a wireless management frame such as a beacon transmitted from a corresponding device, using an AP or Bluetooth device provided in the photographing prohibited area, so that a warning message may be informed to a mobile terminal having received set bits or a camera API may be prevented from being operated.

### SUMMARY OF THE INVENTION

The present invention is directed to a system and method for informing photographing which may inform surrounding mobile terminals that photographing is currently performed at the time of photographing of still images or moving images in a mobile terminal equipped with a camera function, using a wireless communication function, so that the surrounding mobile terminals may easily recognize that photographing is currently performed.

The present invention is also directed to a system and method for informing photographing using wireless communication which may inform a mobile terminal that photographing is prohibited in a photographing prohibited area to thereby warn of photographing, and block operations of a camera application programming interface (API) to thereby induce to restrict photographing.

According to an aspect of the present invention, there is provided a system for informing photographing using wireless communication including: a first mobile terminal that transmits a management frame including a state field for photographing function activated state information to surrounding mobile terminals via a wireless network when performing a photographing mode; and a second mobile terminal that receives the management frame transmitted from the first mobile terminal, and displays a message for informing that the first mobile terminal whose photographing function is activated is present in a periphery in accordance with the photographing function activated state information of the state field of the received management frame.

Here, when a wireless communication function is not activated at the time of performing the photographing mode, the first mobile terminal may activate the wireless communication function.

Also, the wireless network may include at least one of a wireless local area network (LAN) and a Bluetooth network.

Also, the first mobile terminal may activate a photographing function field allocated to the transmitted management frame so as to retrieve surrounding mobile terminals for wireless communication, and then transmit the management frame to thereby transmit the photographing function activated state information.

Also, the system for informing photographing may further include a wireless communication device that receives the photographing function activated state information transmitted from the first mobile terminal, wherein the wireless communication device may transmit, to the first mobile terminal, a message for informing that the first mobile terminal is located within a photographing prohibited area when the first mobile terminal is located within the photographing prohibited area.

Also, when receiving the message for informing that the first mobile terminal is located within the photographing prohibited area from the wireless communication device, the first mobile terminal may display the message or restrict an operation of a camera application programming interface (API).

Also, the wireless communication device may include at least one of an access point (AP) or a Bluetooth device.

Also, the wireless communication device may acquire media access control (MAC) address information, ID information, a photographing function activated time, and the number of times of photographing of the first mobile terminal.

According to another aspect of the present invention, there is provided a method for informing photographing using wireless communication including: transmitting, by a first mobile terminal whose photographing mode is performed, a management frame including a state field for photographing function activated state information to surrounding mobile terminals via a wireless network; and displaying, by a second mobile terminal having received the management frame transmitted from the first mobile terminal, a message for informing that the first mobile terminal whose photographing function is activated is present in a periphery in accordance with the photographing function activated state information of the state field of the received management frame.

Here, when a wireless communication function is not activated at the time of performing the photographing mode, the first mobile terminal may activate the wireless communication function, and then transmit the photographing function activated state information.

Also, the wireless network may include at least one of a wireless LAN and a Bluetooth network.

Also, the first mobile terminal may activate a photographing function field allocated to the transmitted management frame so as to retrieve surrounding mobile terminals for wireless communication, and then transmit the management frame to thereby transmit the photographing function activated state information.

Also, the method for informing photographing may further include receiving, by a wireless communication device, the photographing function activated state information transmitted from the first mobile terminal, and transmitting, to the first mobile terminal, a message for informing that the first mobile terminal is located within a photographing prohibited area when the first mobile terminal is located within the photographing prohibited area.

Also, the method for informing photographing may further include, when the first mobile terminal receives the message for informing that the first mobile terminal is located within the photographing prohibited area from the wireless communication device, displaying, by the first mobile terminal, the message or restricting an operation of a camera API.

Also, the wireless communication device may include at least one of an AP or a Bluetooth device.

Also, the wireless communication device may acquire MAC address information, ID information, a photographing function activated time, and the number of times of photographing of the first mobile terminal.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a configuration diagram illustrating a system for informing photographing using a wireless local area network (LAN) function according to an embodiment of the present invention;

FIG. 2 is a configuration diagram illustrating a system for informing photographing using a Bluetooth function according to an embodiment of the present invention; and

FIG. 3 is a flowchart illustrating an operation of informing photographing of a system for informing photographing using a wireless communication function according to an embodiment of the present invention.

### DETAILED DESCRIPTION OF EXEMPLARY EMBODIMENTS

Example embodiments of the present invention are disclosed herein. Also, specific structural and functional details disclosed herein are merely representative for purposes of describing the example embodiments of the present invention. However, the example embodiments of the present invention may be embodied in many alternative forms and should not be construed as limited to example embodiments of the present invention set forth herein. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a”, “an,” and “the” are intended to include the plural forms as well, unless the context clearly indicates otherwise.

Hereinafter, preferred embodiments of the present invention will be described in detail with reference to the accompanying drawings. When it is determined that the detailed description of known art related to the present invention may obscure the gist of the present invention, the detailed description thereof will be omitted.

The present invention proposes a technical security method in which bits for informing that photographing is prohibited may be set in a wireless management frame such as a beacon transmitted from a corresponding device, using an access point (AP) or Bluetooth device provided in a photographing prohibited area, so that a warning message may be informed to a mobile terminal having received set bits or a camera application programming interface (API) may be prevented from being operated.

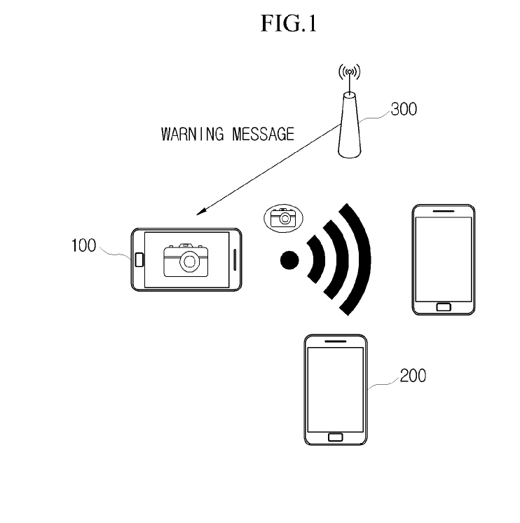

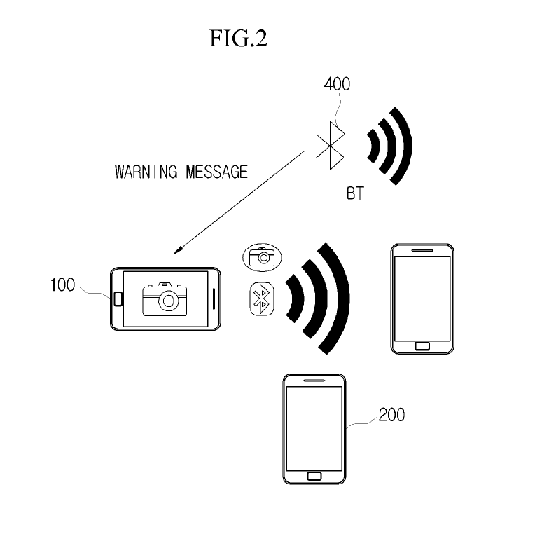

FIG. 1 is a configuration diagram illustrating a system for informing photographing using a wireless local area network (LAN) function according to an embodiment of the present invention, and FIG. 2 is a configuration diagram illustrating a system for informing photographing using a Bluetooth function according to an embodiment of the present invention.

Referring to FIGS. 1 and 2, the system for informing photographing according to an embodiment of the present invention may include a first mobile terminal 100 and a second mobile terminal 200 which may be equipped with a wireless LAN function or a Bluetooth function, respectively, and further include wireless communication devices 300 and 400.

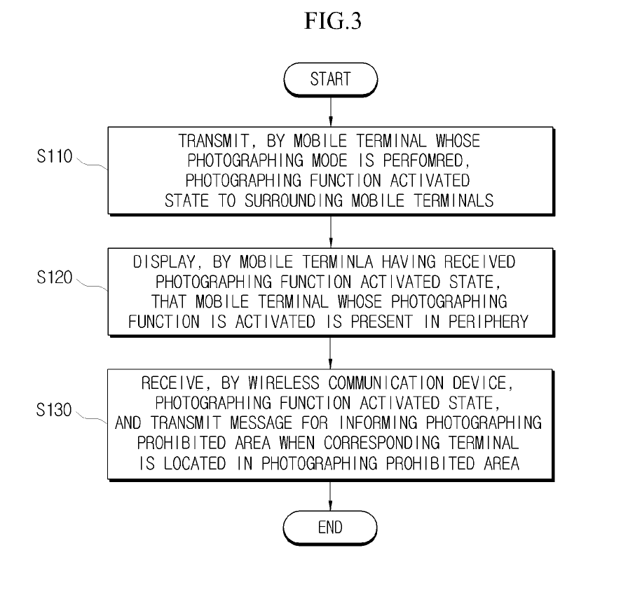

That is, the system for informing photographing according to an embodiment of the present invention may use the wireless LAN function as shown in FIG. 2, and may be implemented using the Bluetooth function as shown in FIG. 3. However, the system for informing photographing according to an embodiment of the present invention may be implemented by utilizing a variety of wireless communication methods other than the wireless LAN or the Bluetooth.

In this instance, one of the first mobile terminal 100 and the second mobile terminal 200 is a device for photographing still images or moving images to transmit photographing function activated state information. The other one of the first mobile terminal 100 and the second mobile terminal 200 is a device that receives the photographing function activated state information.

Meanwhile, the system for informing photographing may include one or a plurality of the first mobile terminal 100 and the second mobile terminal 200.

Hereinafter, an example in which the system for informing photographing includes one first mobile terminal 100 that photographs still images or moving images and a plurality of second mobile terminals 200 will be described.

When a camera photographing function is activated, the first mobile terminal 100 determines whether a wireless LAN function (Wi-Fi or Wi-Fi Direct) or a Bluetooth function which is used to communicate with surrounding mobile terminals is activated, and activates the corresponding function when the corresponding function is not activated.

In addition, when the camera photographing function is activated, the first mobile terminal 100 transmits photographing function activated state information to the surrounding mobile terminal whose wireless LAN function or Bluetooth function is activated, using a management frame such as a beacon, for example, a beacon probe frame, a service discovery request frame, or an action frame.

That is, the first mobile terminal 100 may transmit the photographing function activated state to the surrounding mobile terminal whose wireless LAN function or Bluetooth function is activated, and in this instance, the photographing function activated state may be set in the beacon probe frame, the service discovery request frame, or the action frame to be transmitted.

Meanwhile, when receiving the photographing function activated state transmitted from the first mobile terminal 100, the second mobile terminal 200 displays that a mobile terminal whose photographing function is activated is present in a periphery, so that a user of the second mobile terminal may recognize the presence of the mobile terminal.

The wireless communication devices 300 and 400 receive a frame including the photographing function activated state information transmitted from the first mobile terminal 100, and determine whether the first mobile terminal 100 is located within a photographing prohibited area using the photographing function activated state information included in the frame.

When the first mobile terminal 100 is located within the photographing prohibited area, a message for informing that the first mobile terminal 100 is located within the photographing prohibited area may be transmitted to the first mobile terminal 100 through the wireless communication devices 300 and 400.

In this instance, when receiving the message for informing that the first mobile terminal 100 is located within the photographing prohibited area from the wireless communication devices 300 and 400, the first mobile terminal 100 displays the corresponding message or restricts an operation of a camera API.

Meanwhile, the wireless communication devices 300 and 400 may be an AP 300 or a Bluetooth device 400, and in FIG. 1, an example in which the AP is used as the wireless communication device is shown, and in FIG. 2, an example in which the Bluetooth device is used as the wireless communication device is shown.

In addition, the wireless communication devices 300 and 400 may acquire ID information, photographing function activated time information, the number of times of photographing, and the like of the first mobile terminal 100.

Hereinafter, the system for informing photographing using the wireless LAN function will be described in more detail. When the photographing function is activated and a Wi-Fi or Wi-Fi Direct function is activated, the first mobile terminal 100 may receive a beacon from the surrounding AP 300, transmit a probe request message for retrieving the location of the surrounding mobile terminal, or transmit a management frame such as a service query message, a public action frame, or the like in order to check services provided from the surrounding mobile terminal.

In this instance, when a camera sensor is operated while including a photographing function field capable of displaying a photographing function state within the management frame, that is, when the photographing function is activated, the system for informing photographing using the wireless LAN function may activate the corresponding field to transmit the activated corresponding field to the surrounding terminals, so that the fact that the corresponding camera is currently operated may be explicitly informed to the surrounding terminals.

In this instance, the management frame such as the beacon includes at least one of media access control (MAC) address information, terminal ID information, terminal capacity information of an originating mobile terminal, bit information indicating that a camera is activated for photographing, and bit information indicating that camera photographing is prohibited in a camera photographing prohibited area, and therefore the surrounding mobile terminals having received the management frame may recognize that photographing is currently performed in a periphery, and acquire additional information about the corresponding device while informing the corresponding user that photographing is currently performed in the periphery.

Meanwhile, when the first mobile terminal 100 transmits the management frame including the photographing function activated state information to the surrounding mobile terminals, a fixed device such as the AP 300 may also receive the management frame. Here, when the AP 300 is located in the photographing prohibited area, the fact that the AP is located in the photographing prohibited area may be transmitted through a response message to the management frame such as a probe request message.

In this instance, the first mobile terminal 100 that has received, from the AP 300, the message for informing that the corresponding device is located within the photographing prohibited area may display a warning message indicating that photographing is prohibited in the photographing prohibited area or restrict the operation of the camera API.

Hereinafter, the system for informing photographing using the Bluetooth function will be described in more detail. When the photographing function is activated and the Bluetooth function is activated, a field indicating that the corresponding camera is activated may be set within a beacon or a query message which is used for paring with the surrounding mobile terminals, and the set field may be transmitted.

The surrounding mobile terminals whose Bluetooth function is activated may receive the beacon, the query message, or the like, recognize that a camera of the surrounding mobile terminal is operated, and inform a user of the recognized result.

In this instance, the Bluetooth device 400 provided within a service area may also receive such a message. Here, when the first mobile terminal 100 is located in the photographing prohibited area, the Bluetooth device 400 may set a field for informing the first mobile terminal 100 that photographing is prohibited, and transmit a response message to a query.

The first mobile terminal 100 having received the response message may recognize that photographing is prohibited, and display a warning message or restrict the operation of the camera API.

FIG. 3 is a flowchart illustrating an operation of informing photographing of a system for informing photographing using a wireless communication function according to an embodiment of the present invention.

Referring to FIG. 3, in operation S110, the mobile terminal 100 whose photographing mode is performed may transmit a photographing function activated state to the surrounding mobile terminals using a wireless communication function.

In this instance, when the wireless communication function is not activated upon performing a photographing mode, the first mobile terminal 100 may activate the wireless communication function, and then transmit photographing function activated state information.

Meanwhile, the first mobile terminal 100 may use a wireless LAN function or a Bluetooth function as the wireless communication function.

In addition, the first mobile terminal 100 may activate a photographing function field allocated to a management frame that is transmitted in order to retrieve surrounding mobile terminals for wireless communication, and then transmit the photographing function activated state by transmitting the management frame.

In operation S120, after the photographing function activated state is transmitted from the first mobile terminal 100, the second mobile terminal 200 that has received the photographing function activated state transmitted from the first mobile terminal 100 may display that a mobile terminal whose photographing function is activated is present in a periphery.

In addition, in operation S130, the wireless communication devices 300 and 400 receive the photographing function activated state transmitted from the first mobile terminal 100, and transmit, when the first mobile terminal 100 is located in a photographing prohibited area, a message for informing that the first mobile terminal 100 is located in the photographing prohibited area to the first mobile terminal 100.

In this instance, when receiving the message for informing that the first mobile terminal 100 is located in the photographing prohibited area from the wireless communication devices 300 and 400, the first mobile terminal 100 may display the corresponding message or restrict an operation of a camera API.

In addition, the wireless communication devices 300 and 400 may acquire ID information, a photographing function activated time, and the number of times of photographing of the first mobile terminal 100.

As described above, according to the embodiments of the present invention, the mobile terminal whose photographing function is activated may transmit the photographing function activated state using the wireless communication, and therefore the surrounding mobile terminals may recognize that the mobile terminal whose photographing function is activated is present in the periphery.

In addition, when the corresponding mobile terminal is located in the photographing prohibited area, the wireless communication device that has received the photographing function activated state may inform a user that the corresponding mobile terminal is located in the photographing prohibited area and induce photographing restrictions.

In summary, according to the present invention, in order to complement an existing technology that prevents secret photographing or photographing without permission which becomes a social issue, using a photographing sound, an LED, and an operation of a flash, bits for informing that still image (moving image) photographing is activated may be set in the management frame of the wireless communication function and the set bits may be informed to the surrounding terminals, and therefore it is possible to meet the user's desire with the purpose of photographing a sleeping baby, a pet, or the like quietly.

In addition, according to the present invention, photographing prohibition bits may be set in the AP or Bluetooth device in the photographing prohibited area, and a message for informing that the corresponding terminal is located in the photographing prohibited area may be transmitted to a mobile terminal or the like equipped with a camera through the management frame such as the beacon, so that the transmitted message may be displayed in the mobile terminal or the operation of the camera API function may be blocked, and therefore the user may easily recognize the photographing prohibited area.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A system for informing photographing using wireless communication comprising:
a first mobile terminal that transmits a management frame including a state field for photographing function activated state information to surrounding mobile terminals via a wireless network when performing a photographing mode; and
a second mobile terminal that receives the management frame transmitted from the first mobile terminal, and displays a message for informing that the first mobile terminal whose photographing function is activated is present in a periphery in accordance with the photographing function activated state information of the state field of the received management frame.

2. The system for informing photographing of claim 1, wherein, when a wireless communication function is not activated at the time of performing the photographing mode, the first mobile terminal activates the wireless communication function.

3. The system for informing photographing of claim 1, wherein the wireless network includes at least one of a wireless local area network (LAN) and a Bluetooth network.

4. The system for informing photographing of claim 1, wherein the first mobile terminal activates a photographing function field allocated to the transmitted management frame so as to retrieve surrounding mobile terminals for wireless communication, and then transmits the management frame to thereby transmit the photographing function activated state information.

5. The system for informing photographing of claim 1, further comprising:
a wireless communication device that receives the photographing function activated state information transmitted from the first mobile terminal,
wherein the wireless communication device transmits, to the first mobile terminal, a message for informing that the first mobile terminal is located within a photographing prohibited area when the first mobile terminal is located within the photographing prohibited area.

6. The system for informing photographing of claim 5, wherein, when receiving the message for informing that the first mobile terminal is located within the photographing prohibited area from the wireless communication device, the first mobile terminal displays the message or restricts an operation of a camera application programming interface (API).

7. The system for informing photographing of claim 5, wherein the wireless communication device includes at least one of an access point (AP) or a Bluetooth device.

8. The system for informing photographing of claim 5, wherein the wireless communication device acquires media access control (MAC) address information, ID information, a photographing function activated time, and the number of times of photographing of the first mobile terminal.

9. A method for informing photographing using wireless communication comprising:
transmitting, by a first mobile terminal whose photographing mode is performed, a management frame including a state field for photographing function activated state information to surrounding mobile terminals via a wireless network; and
displaying, by a second mobile terminal having received the management frame transmitted from the first mobile terminal, a message for informing that the first mobile terminal whose photographing function is activated is present in a periphery in accordance with the photographing function activated state information of the state field of the received management frame.

10. The method for informing photographing of claim 9, wherein, when a wireless communication function is not activated at the time of performing the photographing mode, the first mobile terminal activates the wireless communication function, and then transmits the photographing function activated state information.

11. The method for informing photographing of claim 9, wherein the wireless network includes at least one of a wireless LAN and a Bluetooth network.

12. The method for informing photographing of claim 9, wherein the first mobile terminal activates a photographing function field allocated to the transmitted management frame so as to retrieve surrounding mobile terminals for wireless communication, and then transmits the management frame to thereby transmit the photographing function activated state information.

13. The method for informing photographing of claim 9, further comprising:
receiving, by a wireless communication device, the photographing function activated state information transmitted from the first mobile terminal, and transmitting, to the first mobile terminal, a message for informing that the first mobile terminal is located within a photographing prohibited area when the first mobile terminal is located within the photographing prohibited area.

14. The method for informing photographing of claim 13, further comprising, when the first mobile terminal receives the message for informing that the first mobile terminal is located within the photographing prohibited area from the wireless communication device:
displaying, by the first mobile terminal, the message or restricting an operation of a camera API.

15. The method for informing photographing of claim 13, wherein the wireless communication device includes at least one of an AP or a Bluetooth device.

16. The method for informing photographing of claim 13, wherein the wireless communication device acquires MAC address information, ID information, a photographing function activated time, and the number of times of photographing of the first mobile terminal.
